(19) United States
(12) Patent Application Publication
(10) Pub. No.: US 2013/0046737 A1
(43) Pub. Date: Feb. 21, 2013

(54) SURVEY SYSTEM AND METHOD

(71) Applicants: Robert A. Bleile, Perrysburg, OH (US); Emil Tsankov, Varna (BG)

(72) Inventors: Robert A. Bleile, Perrysburg, OH (US); Emil Tsankov, Varna (BG)

(21) Appl. No.: 13/584,863

(22) Filed: Aug. 14, 2012

Related U.S. Application Data
(60) Provisional application No. 61/523,522, filed on Aug. 15, 2011.

(51) Int. Cl. G06F 17/30

(52) U.S. Cl. 707/687; 707/E17.134

(57) ABSTRACT

A survey system of the present invention includes a mobile-computing device having a user interface for receiving survey data from respondents, a management server including a survey data validation module, and a terminal having a user interface. The mobile-computing device includes a survey application which encodes the survey data with at least one identifier and transmits the encoded survey data to the management server. The survey data validation feature of the management server analyzes the encoded survey data for validity and determines a probability of authenticity of the survey data. Statistical survey results, as well as the probability of authenticity of the survey data is presented to an end user through the user interface of the terminal.

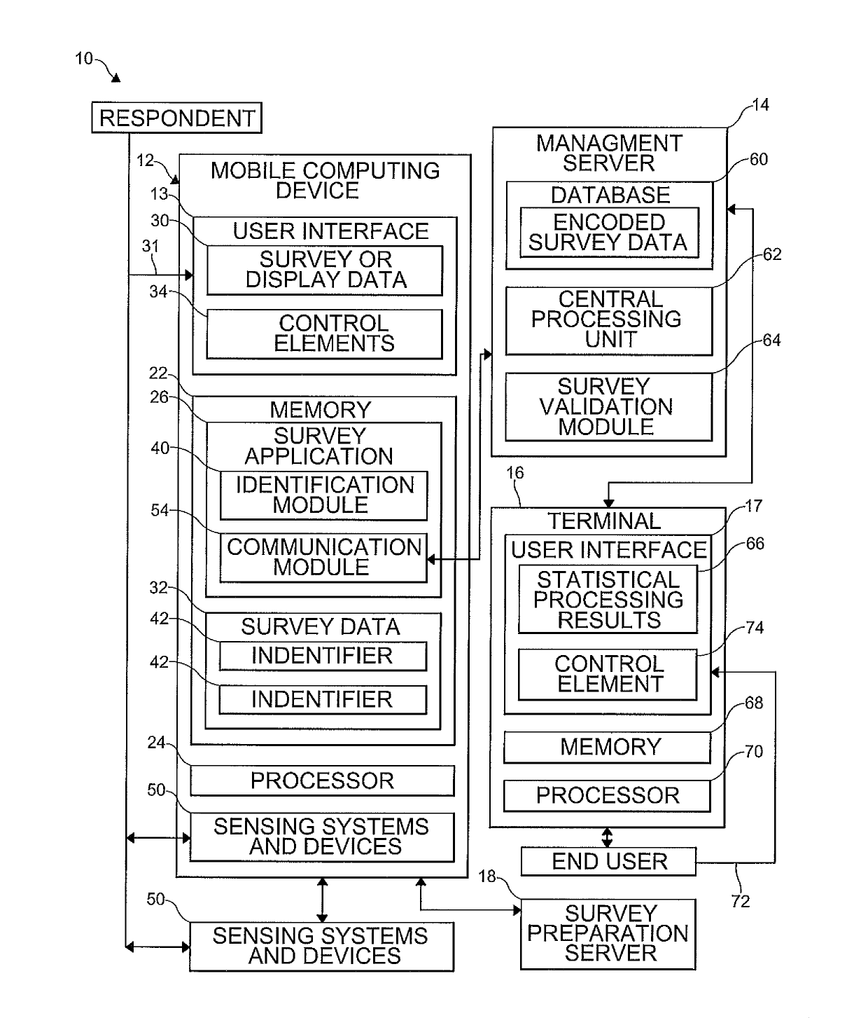

### CROSS-REFERENCE TO RELATED APPLICATION

This application claims the benefit of U.S. Provisional Patent Application Ser. No. 61/523,522 filed Aug. 15, 2011, the entire disclosure of which is hereby incorporated herein by reference.

### FIELD OF THE INVENTION

The invention relates to a survey system and method, and more particularly, to a survey system and method which includes a survey data validation feature.

### BACKGROUND OF THE INVENTION

Surveys are frequently used to obtain information from respondents regarding various topics. For example, surveys have historically been used to gather information regarding respondents' interests, motivations, perceptions, preferences, habits, and the like. Surveys have been delivered in many forms including by oral and written questions and are generally conducted after a respondent has vacated a store, location, or other venue in which an experience of the respondent is desired to be known. Responses to the survey questions can be analyzed and used to obtain statistical information about a group of respondents, which can be further extrapolated to a larger population.

Typically, the survey responses are amassed at a survey center and inputted by an operator into a processor for tallying. After the statistical processing of the responses, the findings of the survey are reported to a client who had requested the survey. However, such collection and processing of the survey responses at the survey center is extremely inefficient. Another problem associated with such a survey method is ensuring data validity. Independent contractors are typically employed to conduct the surveys. These contractors are typically given targets to reach in terms of the number of survey respondents. Accordingly, there is an incentive for the contractors, themselves, to complete fraudulent or duplicate surveys to meet the targets.

Therefore, it would be desirable to develop a survey system and method which includes a survey data validation feature.

### SUMMARY OF THE INVENTION

In concordance and agreement with the present invention, a survey system and method which includes a survey data validation feature, has surprisingly been discovered.

In one embodiment, the survey application comprises: an identification module configured to associate at least one identifier with an entry of survey data, wherein the entry of the survey data and the at least one identifier associated therewith are analyzed to determine an authenticity of the survey data.

In another embodiment, the survey system comprises: a mobile-computing device including a survey application configured to associate at least one identifier with an entry of survey data; and a management server for receiving the entry of the survey data and the at least one identifier associated therewith, wherein the management server is configured to analyze the entry of the survey data and the at least one identifier associated therewith to determine an authenticity of the survey data.

The invention also provides a survey method which comprises the steps of: associating at least one identifier with an entry of survey data; and analyzing the entry of the survey data and the at least one identifier associated therewith to determine an authenticity of the survey data.

### DESCRIPTION OF THE DRAWING

The above, as well as other advantages of the present invention, will become readily apparent to those skilled in the art from the following detailed description of a preferred embodiment when considered in the light of the accompanying drawing which is a schematic block diagram of a survey system according to an embodiment of the present invention.

### DESCRIPTION OF THE PREFERRED EMBODIMENTS

The following detailed description and appended drawing describe and illustrate an exemplary embodiment of the invention. The description and drawing serve to enable one skilled in the art to make and use the invention, and are not intended to limit the scope of the invention in any manner. In respect of the method disclosed, the order of the steps presented is exemplary in nature, and thus, is not necessary or critical.

The drawing shows a survey system 10 according to an embodiment of the present invention. As shown, the system 10 includes a mobile computing device (MCD) 12 having a user interface 13, a management server 14, and a terminal 16 having a user interface 17. The system 10 may also include a survey preparation server 18 as a separate component or integrated into the MCD 12 or the management server 14, if desired. It is understood that the system 10 may include other additional components necessary for operation of the system 10.

The MCD 12 is any device suitable to collect survey data including, but not limited to those which are categorized by the generic, technological terms of Smartphone, portable consumer electronic device, personal computing tablet, personal lap-top computer, and personal notebook computer. Examples of such MCDs 12 are the Apple iPhone, Apple iPad, Blackberry Playbook, Blackberry Tablet, Samsung Galaxy Tab, Motorola Droid, HTC Android, and numerous others sold by Apple, HTC, Motorola, Dell, Samsung, HP, Sanyo, Blackberry, Toshiba, Acer, Lenovo, Asus, and the like.

The MCD 12 includes a memory 22 and a processor 24. The memory 22 may be a single storage device or may be multiple storage devices. Portions of the memory 22 may also be located on the processor 24. Furthermore, the memory 22 may be a solid state storage system, a magnetic storage system, an optical storage system, or any other suitable storage system. In certain embodiments, the memory 22 is configured to store a survey program or application 26. Other data may be stored in the memory 22 as described hereinafter.

The processor 24 is configured to retrieve from the memory 22 and execute the survey application 26 of the MCD 12. It is understood that the configuration and functions of the processor 24 may be adjusted in real-time or pre-programmed by the original equipment manufacturer (OEM) or user. It is further understood that the functions of the processor 24 may have stored settings that may be recalled and processed, as desired. The survey application 26, which may be embodied within any computer readable medium, includes processor executable instructions for configuring the processor 24 to perform a variety of tasks. In certain embodiments, the survey application 26 configures the processor 24 to generate display data 30 in the form of a survey having questions pertaining to interests, motivations, perceptions, preferences, habits, and the like, and requesting inputs 31 in response thereto. The inputs 31 of each survey 30 completed by a respondent are stored as an individual entry of survey data 32 in the memory 22 of the MCD 12. The inputs 31 can be entered by any means as desired such as by an inputting device (e.g. a finger, a stylus, etc.) or a control element 34 displayed or disposed in the user interface 13, for example.

The survey application 26 includes an identification module 40. The identification module 40 simultaneously generates or collects at least one unique identifier 42 each time the respondent completes the survey 30 on the MCD 12. Accordingly, each identifier 42 is associated with the individual entry of survey data 32 created for the completed survey 30. The identifier 42 can be a single point or stream of information generated or collected before, during, and after the survey 30. The identifier 42 includes, but is not limited to time (e.g. a chronological data registry at a start and a completion of the survey to an n^{th} of a second based upon Greenwich Mean Time of a twenty-four (24) hour day) and date; a spatial orientation (e.g. Euler angles and Tait-Bryan angles), a location (e.g. an earthbound geographic latitude and longitude, a location in respect of sea level, a distance from a surface of the earth, etc.), and a velocity of the MCD 12; a spatial orientation (e.g. Euler angles and Tait-Bryan angles), a location (e.g. an earthbound geographic latitude and longitude, a location in respect of sea level, a distance from the surface of the earth, etc.), and a velocity of the respondent; biometrics of the respondent (e.g. a fingerprint, a retinal print, a pulse, an oxygen saturation level in blood, a skin pigment, a facial image, and voice characteristics such as a frequency, a rate, a volume, an inflection, a pitch, etc.); and human-machine interface characteristics (e.g. a contact location of the inputting instrument on the user interface 13, a velocity of the inputting instrument during contact with the user interface 13, a duration of contact of the inputting instrument with the user interface 13, a style of contact of the inputting instrument with the user interface 13, and a contact pressure of the inputting instrument on the user interface 13).

It is understood that the identifier 42 can be collected and/or generated using various sensing systems and devices 50 such as a global positioning system (GPS), a vibration, a rotation, and/or a motion sensor (e.g. an accelerometer, a gyroscope, etc.), a pulse oximeter, and a microphone, for example. It is further understood that the sensing systems and devices 50 can be internal or external to the MCD 12 such as disposed within the MCD 12, disposed in an accessory to the MCD 12 (e.g. a protective case), or in electrical communication with the MCD 12 (e.g. a wired connection through an input/output port (I/O port) (not shown) of the MCD 12 (e.g. a universal serial bus (USB)), a wireless connection (e.g., a Wi-Fi® communication, a near field communication, and a Bluetooth® communication), for example.

Each of the identifiers 42 is encoded upon each entry of the survey data 32 to ensure an integrity and an authenticity of the survey data 32 collected, thereby militating against fraudulent and duplicate survey data 32. The survey application 26 may also include a communication module 54 which transmits an encoded survey data 52 to the management server 14. Transmission of the encoded survey data 52 to the management server 14 can be initiated by the surveyor, the respondent, or any other authorized personnel, as desired, and at any time as desired such as instantaneously before, during, or after completion of the survey 30, at regular predetermined times and/or dates, or when the memory 22 of the MCD 12 has reached a predetermined level, for example.

The management server 14 registers and stores the encoded survey data 52 in a database 60. The database 60 may be any storage device for storing data. The database 60 is configured to communicate with the MCD 12 to send and receive data such as the encoded survey data 52, for example. The database 60 is also in communication with the terminal 16, wherein a command signal received from the user interface 17 of the terminal 16 controls at least one of a storing, a retrieving, and an organizing of the encoded survey data 52 stored in the database 60. In the embodiment shown, the database 60 is disposed in the management server 14. However, the database 60 may be disposed in a remote location and connected to the management server 14 and the terminal 16 via the Internet or other suitable communication means. It is understood that the database 60 may be associated with any MCD 12 and may store any data. It is further understood that the encoded survey data 52 stored in the database 60 may be populated by a plurality of MCDs 12 in various locations.

The stored encoded survey data 52 is retrieved from the database 60 by a central processing unit (CPU) 62 of the management server 14 and processed. A survey data validation module 64 of the management server 14 analyzes the encoded survey data 52 to locate fraudulent or duplicate entries of the encoded survey data 52 and determine a probability of authenticity of the encoded survey data 52. In a non-limiting example, the survey data validation module 64 analyzes the inputs 31 and the identifier(s) 42 from one individual entry 32 to determine a probability of authenticity thereof. In another non-limiting example, the survey data validation module 64 analyzes the encoded survey data 52 by comparing the inputs 31 and the identifiers 42 from at least two individual entries of the encoded survey data 52 to determine whether the inputs 31 and the identifiers 42 are valid. For example, when the inputs 31 and the identifiers 42 are substantially identical for multiple entries of the encoded survey data 52, the survey data validation module 64 determines one of the entries of the encoded survey data 52 to be valid and the other remaining entries of the encoded survey data 52 to be duplicates, thereby decreasing the probability of authenticity of the survey data 32. In another example, when the inputs 31 are substantially different and the identifiers 42 are substantially similar for multiple entries of the encoded survey data 52, the survey data validation module 64 determines that the entries of the encoded survey data 52 may be fraudulent, thereby decreasing the probability of authenticity of the survey data 32. In yet another example, when the inputs 31 are substantially different and the identifiers 42 are substantially different for multiple entries of the encoded survey data 52, the survey data validation module 64 determines that the entries of the encoded survey data 52 are valid, thereby increasing the probability of authenticity of the survey data 32.

In addition to being analyzed for survey data validation purposes, it is understood that the identifiers 42 can also be processed by the management server 14 for statistical analysis. In certain embodiment, the CPU 62 analyzes the identifiers 42 of the encoded survey data 52 and generates statistical processing results 66. The statistical processing results 66 of the management server 14 may be assembled as visible data such as HTML data, for example, and presented to an end user through the user interface 17 of the terminal 16. The probability of authenticity can also be reported to the end user through the user interface 17 of the terminal 16 in the form of a probability of validity score or any other means of conveying the probability of authenticity to the end user.

The terminal 16 is any device suitable to display information including, but not limited to those which are categorized by the generic, technological terms of Smartphone, portable consumer electronic device, personal computing device or tablet, personal lap-top or desktop computer, and personal notebook computer. Examples of such terminals 16 are the Apple iPhone, Apple iPad, Blackberry Playbook, Blackberry Tablet, Samsung Galaxy Tab, Motorola Droid, HTC Android, and numerous others sold by Apple, HTC, Motorola, Dell, Samsung, HP, Sanyo, Blackberry, Toshiba, Acer, Lenovo, Asus, and the like. As illustrated, the terminal 16 includes a memory 68 and a processor 70. The memory 68 may be a single storage device or may be multiple storage devices. Portions of the memory 68 may also be located on the processor 70. Furthermore, the memory 68 may be a solid state storage system, a magnetic storage system, an optical storage system, or any other suitable storage system. In certain embodiments, the memory 68 is configured to store personalized information of the end user such as login or username and password, display settings and preferences, for example. Other data may be stored in the memory 68 as desired.

The processor 70 is configured to retrieve the statistical processing results 66 and the probability of authenticity of the survey data 30 from the management server 14. It is understood that the configuration and functions of the processor 70 may be adjusted in real-time or pre-programmed by the original equipment manufacturer (OEM) or user. It is further understood that the functions of the processor 70 may have stored settings that may be recalled and processed, as desired. In certain embodiments, the processor 70 of the terminal 16 is configured to receive inputs 72 via the user interface 17. The inputs 72 can be entered by any means as desired such as by an inputting device (e.g. a finger, a stylus, etc.) or a control element 74 displayed or disposed in the user interface 17, for example.

In operation, a surveyor or the respondent activates the survey application 26 of the MCD 12. Upon activation, the survey 30 is displayed on the user interface 13 of the MCD 12. The respondent then operates the MCD 12 and uses the inputting instrument to respond by entering the inputs 31 to the survey 30 into the user interface 13. Simultaneously, the identification module 40 captures and/or generates the identifier(s) 42 associated with the survey 30 being completed by the respondent. After completion of the survey 30, the inputs 31 are stored in the memory 22 of the MCD 12 as an individual entry of survey data 32 encoded with the identifier(s) 42. The encoded survey data 52 is then transmitted by the MCD 12 to the management server 14.

Upon receipt of the encoded survey data from the MCD 12, the management server 14 registers and stores the encoded survey data 52 in a database 60. The stored encoded survey data 52 is then retrieved from the database 60 by the CPU 62 of the management server 14 and processed. A survey data validation module 64 of the management server 14 analyzes the encoded survey data 52 to locate any fraudulent or duplicate entries of the encoded survey data 52 and determines the probability of authenticity of the encoded survey data 52. Optionally, the identifiers 42 are also processed by the management server 14 for statistical analysis. In particular, the identifiers 42 of the encoded survey data 52 are analyzed by the CPU 62 to generate the statistical processing results 66. The processor 70 of the terminal 16 retrieves the probability of authenticity of the survey data 30 and the statistical processing results 66 from the management server 14. The probability of authenticity is then reported to the end user through the user interface 17 of the terminal 16. The statistical processing results 66 can also be assembled and presented to the end user through the user interface 17 of the terminal 16.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A survey application, comprising:
an identification module configured to associate at least one identifier with an entry of survey data, wherein the entry of the survey data and the at least one identifier associated therewith are analyzed to determine an authenticity of the survey data.

2. The survey application of claim 1, further comprising a communication module configured to transmit the entry of the survey data and the at least one identifier associated therewith to a management server.

3. The survey application of claim 2, wherein at least one of the identification module and the communication module is stored in a memory of a mobile-computing device.

4. The survey application of claim 2, wherein the management server is configured to analyze the entry of the survey data and the at least one identifier associated therewith to determine the authenticity of the survey data.

5. The survey application of claim 1, wherein the authenticity of the survey data is displayed on a terminal accessible by an end user.

6. The survey application of claim 1, wherein the entry of the survey data is at least one input by a respondent in response to a survey.

7. The survey application of claim 1, wherein the at least one identifier is at least one of a single point and a stream of information.

8. The survey application of claim 1, wherein the at least one identifier is at least one of generated and collected at least one of before, during, and after a survey.

9. The survey application of claim 1, wherein the at least one identifier is at least one of generated and collected using at least one sensing system and sensing device.

10. A survey system, comprising:
a mobile-computing device including a survey application configured to associate at least one identifier with an entry of survey data; and
a management server for receiving the entry of the survey data and the at least one identifier associated therewith, wherein the management server is configured to analyze the entry of the survey data and the at least one identifier associated therewith to determine an authenticity of the survey data.

11. The survey system of claim 10, wherein the survey application includes an identification module configured to associate at least one identifier with an entry of survey data.

12. The survey system of claim 10, wherein the survey application includes a communication module configured to transmit the entry of the survey data and the at least one identifier associated therewith to the management server.

13. The survey system of claim 10, wherein the survey application is stored in a memory of a mobile-computing device.

14. The survey system of claim 10, wherein the management server includes a survey data validation module to analyze the entry of the survey data and the at least one identifier associated therewith to determine the authenticity of the survey data.

15. The survey system of claim 10, wherein a probability of the authenticity of the survey data is displayed on a terminal for an end user.

16. A survey method, comprising the steps of:
associating at least one identifier with an entry of survey data; and
analyzing the entry of the survey data and the at least one identifier associated therewith to determine an authenticity of the survey data.

17. The survey method of claim 16, wherein the step of associating the at least one identifier with the entry of the survey data is completed by an identification module of a survey application.

18. The survey method of claim 16, wherein the step of analyzing the entry of the survey data and the at least one identifier associated therewith is completed by a survey validation module of a management server.

19. The survey method of claim 16, further comprising the step of transmitting the entry of survey and the at least one identifier associated therewith to a management server.

20. The survey method of claim 16, wherein the step of transmitting the entry of survey and the at least one identifier associated therewith to the management server is completed by a communication module of a survey application.
